(19) United States
(12) Patent Application Publication
(10) Pub. No.: US 2023/0368594 A1
(43) Pub. Date: Nov. 16, 2023

(54) Method for Granting an Access Authorization for Luggage Compartments Comprised by a Vehicle, Application and Vehicle

(71) Applicant: DAIMLER AG, Stuttgart (DE)

(72) Inventors: Jan MAYER, Ulm (DE); Marvin RUF, Neu-Ulm (DE)

(21) Appl. No.: 18/245,054

(22) PCT Filed: Jul. 27, 2021
(86) PCT No.: PCT/EP2021/070937

§ 371 Date: Mar. 13, 2023

(30) Foreign Application Priority Data
Sep. 14, 2020 (DE) 10 2020 005 617.2

(51) Int. Cl. G07C 9/00; G07C 9/27; G06Q 10/02

(52) U.S. Cl. CPC G07C 9/00571; G07C 9/00896; G07C 9/00309; G07C 9/27; G06Q 10/02; G07C 2009/0092; G07C 2209/62

(57) ABSTRACT

A method for granting an access authorization for luggage compartments of a vehicle that has at least two luggage compartments, includes booking of a luggage compartment for a journey of the vehicle. At least one of the luggage compartments of the vehicle is assigned to the passenger via a central computing unit such that the passenger receives an access authorization. A request for granting a release of the at least one luggage compartment assigned to the passenger is input into a device. The access authorization of a person inputting the request is checked via a computing unit inside of the vehicle and/or the central computing unit. If checking by the computing unit, the computing unit obtains access authorization data from the central computing unit. If the person inputting the request is authorized, the at least one luggage compartment assigned to the passenger is released.

### BACKGROUND AND SUMMARY OF THE INVENTION

The invention relates to a method for granting an access authorization for luggage compartments comprised by a vehicle, to an application executed on a mobile device of a passenger, and to a vehicle of the type defined herein.

High-floor buses are known from the prior art, which comprise a luggage compartment arranged between a passenger space and a floor panel of the bus. A luggage compartment having a particularly high capacity whilst simultaneously efficiently using an available installation space can thus be designed. Access to the luggage compartment typically occurs via pivotable or foldable cladding elements of the bus body provided on the side of the bus. Only a few, for example two to three, such flaps are generally provided for this purpose per side.

Such a design of a bus luggage compartment entails a series of disadvantages. Firstly, flaps need to be unlocked manually, mostly by a bus driver, in order to be opened. The bus driver must thus be active at every stop if a passenger wants to load or unload an item of luggage. Loading or unloading the items of luggage can here be problematic due to a design of the luggage compartment as a coherent space. Passengers often load their luggage into the luggage compartment themselves, whereby these items of luggage are loaded into the luggage compartment without a recognizable order, and significant effort is thus required to find a particular item of luggage. In particular, items of luggage that are arranged between the item of luggage needing to be found and an open flap of the luggage compartment must be moved or removed for this purpose in some circumstances. The danger additionally arises that the items of luggage can easily be mixed up. It is also possible that, in the case of a partially loaded luggage compartment, items of luggage can slip uncontrollably through the luggage compartment, whereby objects contained by the items of luggage can be damaged, and the items of luggage may be located in a different position in the luggage compartment at the end of a journey than at the beginning in some instances, which additionally increases the difficulty of finding a particular item of luggage. Additionally, there is a non-negligible risk of theft in the case of such a luggage compartment, as access to a plurality of items of luggage located in the luggage compartment is enabled via a single open luggage compartment flap.

To avoid some of these disadvantages, DE 10 2017 115 045 A1 discloses a bus having a luggage compartment that is subdivided into a plurality of storage compartments spatially separated from one another by a device. These storage compartments can respectively have a rolling shutter able to be locked separately according to an embodiment of the invention, whereby a risk of theft can be reduced by preventing access of a third party to such a storage compartment. The storage compartments or flaps that delimit the storage compartments with regard to an environment can further have a device for identifying an assignment of a storage compartment to a passenger or group of passengers, for example in the form of a display. It is disadvantageous, however, that a key is necessary to unlock and lock the storage compartments. Thus, the problem still remains that a person managing the storage compartments must unlock and lock the individual storage compartments with significant effort, or that corresponding keys must be distributed to the passengers before the luggage compartment is loaded and collected again after the luggage compartment is unloaded, which is likewise connected with significant effort. In particular during collection, the danger arises that a passenger accidentally forgets to return a key.

DE 10 2019 126 223 A1 further discloses a vehicle having a body control module equipped to guarantee controlled access to a storage space of the vehicle and a storage device arranged in the storage space. The document further discloses a corresponding method. It is here possible to guarantee access to the storage space and the storage device via receipt of a mobile storage access request via a communication module connected to the body control unit. The mobile storage access request can be sent by a key fob, an application executed on a mobile device or a central computing unit outside the vehicle. This enables access to the storage space and the storage device to be granted to a group of people independently of one another. It is disadvantageous, however, that a group of people can also receive access to the storage space and the storage device simultaneously with the assistance of the mobile storage access request. The danger thus arises that objects can be removed from the storage space and/or storage device even when this is undesirable for a person driving the vehicle. The risk further arises that a first person removes a particular object from the storage space and/or the storage device and a second person who access the storage space and/or the storage device after the first person and requires this object specifically cannot find the object. It is further difficult for just any person to initiate a mobile storage access request. For this purpose, the person must either convince a person authorized for access to release the storage space and the storage device or become a member of a group authorized for access, for example an ambulance service, the police or the fire brigade.

The object of the present invention is to provide an improved method for granting an access authorization for luggage compartments comprised by a vehicle, in which any person can obtain access authorization for at least one of the luggage compartments particularly comfortably, and access of a third party to the luggage compartment of the person is simultaneously reliably prevented. A further object of the present invention is to provide an application with the assistance of which it is possible to carry out such a method, and a vehicle having corresponding luggage compartments.

In a method for granting an access authorization for luggage compartments comprised by a vehicle, the vehicle comprises at least two luggage compartments spatially separated from each other and able to be released and/or locked independently of each other. According to the invention, the method comprises the following method steps:
booking of at least one luggage compartment for a journey from a starting stop to a target stop carried out by at least one vehicle at a pre-determined time by a passenger via a booking portal;
assignment of at least one of the luggage compartments comprised by at least one vehicle carrying out the journey to the passenger via a central computing unit outside the vehicle, whereby the passenger receives an access authorization for precisely this luggage compartment for the duration of the journey;
input of a request for granting a release of the at least one luggage compartment assigned to the passenger in a device for inputting operating actions comprised by the vehicle or a mobile device;
checking the access authorization of a person inputting the request to release the at least one luggage compartment assigned to the passenger via a computing unit inside vehicle and/or the central computing unit outside the vehicle, wherein, in a case of a check of the access authorization by the computing unit inside the vehicle, the computing unit receives or accesses access authorization data from the central computing unit outside the vehicle before carrying out the check; and
in the case that the person inputting the request is authorized for access:
release of the at least one luggage compartment assigned to the passenger via the computing unit inside the vehicle.

With the assistance of the method according to the invention, it is made possible for a passenger to transport their luggage particularly comfortably on a journey with the vehicle. If the passenger has to change on their journey from the starting stop to the target stop, a first luggage compartment can also be booked in a first vehicle used by the passenger, and a second luggage compartment can be booked in a second vehicle used by the passenger after changing. The vehicles can be of the same vehicle type, for example a first and a second bus, or of a different type, for example a bus and a train.

As each passenger of the vehicle can have their own luggage compartment respectively assigned to them, it can be reliably avoided that items of luggage are mixed up, and the spatial separation of the individual luggage compartments from one another prevents the items of luggage from sliding around uncontrollably in a large luggage compartment. If the luggage compartment assigned to the respective passenger can only be opened by the passenger themselves and/or optionally by an authorized person such as a driver of the vehicle, then a risk of theft can additionally be minimized. By giving the access authorization for a respective luggage compartment to a respective passenger via the booking portal, effort in giving access authorizations can be significantly reduced. Thus it is also possible to significantly reduce the complete loading and/or unloading time of the vehicle, as an authorized person such as the driver or a steward of the vehicle no longer has to unlock and lock the individual luggage compartments themselves, and instead the individual passengers can unlock and lock their luggage compartment themselves at a time convenient to them during a stop of the vehicle at a stop.

Thus, it is generally also possible for a passenger to book several luggage compartments for the journey they are going to carry out with the vehicle(s). They can thus bring sufficient luggage with them. It is generally also conceivable that a third party books a luggage compartment for the passenger, and the third party thus does not travel with the vehicle themselves. The booking portal can be designed as an online portal, for example. Assigning the luggage compartment of the vehicle to the passenger occurs via the central computer unit outside the vehicle. The central computing unit can assign the luggage compartments to the passengers according to any pattern. For example, the luggage compartments can be occupied in such an order that a centre of gravity of the vehicle is advantageously changed due to the additional weight installed in the luggage compartments. The individual luggage compartments can also be assigned depending on their spatial position in the vehicle. Thus, for example, the luggage compartments provided at the front of the vehicle are assigned to the passengers first, for example, then luggage compartments arranged in a central portion of the vehicle, and finally luggage compartments arranged in a rear part of the vehicle. Any pattern for assigning the luggage compartments to the passengers can generally be used for this purpose. If a passenger now wants to open their luggage compartment to load their luggage into the luggage compartment, they must transmit a request to release the luggage compartment for this purpose. For this purpose, they can use a mobile device such as a smartphone, for example, which communicates directly with the computing unit inside the vehicle, for example the smartphone can exchange data with the computing unit inside the vehicle via radio, for example Bluetooth, Wi-Fi or NFC. Alternatively or in addition, the mobile device can also communicate with the computing unit inside the vehicle indirectly via the central computing unit outside the vehicle. The mobile device can thus communicate via mobile radio and/or via the internet with the central computing unit outside the vehicle, for example with a backend in the form of a cloud sever, which optionally further processes the data transmitted by the mobile device and then passes the data on to the computing unit inside the vehicle. It is also conceivable that the vehicle comprises at least one device for inputting operating actions, for example a central device for inputting operating actions, or also several devices for inputting operating actions, wherein only some or all of the luggage compartments can have such a device. In order to release the luggage compartment only to the passenger who booked the luggage compartment, the device for inputting operating actions comprises a device for checking the identity of the respective passenger. Thus, if a passenger does not have a mobile device or has not brought the mobile device, they can nevertheless release their luggage compartment with the assistance of the device for inputting operating actions after identification.

Identification or checking of the access authorization can be carried out both by the computing unit inside the vehicle and/or the central computing unit outside the vehicle. Thus, for example, the release request can be sent from the mobile device to the central computing unit outside the vehicle, the request comprising an identifier of the passenger, for example a username or a customer number that is assigned during the booking process by the central computing unit outside the vehicle to a particular vehicle for a particular journey time or to the luggage compartment comprised by the vehicle, and once a current time and a current date correspond to the journey time, the central computing unit outside the vehicle sends a release command to the computing unit inside the vehicle via wireless data communication, which then releases the luggage compartment assigned to the passenger. It is also conceivable that the computing unit inside the vehicle has received or requested access authorization data from the central computing unit outside the vehicle before the journey is due to begin, whereby direct communication can then occur between the mobile device and the computing unit inside the vehicle to release the luggage compartment. This enables improved access to the luggage compartments, for example when a journey is carried out through a region with poor radio reception. To lock or release the luggage compartments, any locking device that can be operated by the computing unit inside the vehicle can be employed. For example, the locking device can be a magnetic lock or any other locking device able to be centrally operated.

An advantageous embodiment of the method provides that the passenger identifies themselves by at least one of the following methods directly at the computing unit inside the vehicle or via the central computing unit outside the vehicle before the release of their at least one baggage compartment assigned to them:
comparison of a current GPS position of the vehicle carrying out the journey with a current GPS position of the passenger, wherein the current GPS position of the passenger is determined by a mobile device of the passenger;
input of an alphanumeric code into the device comprised by the vehicle for inputting operating actions and/or scanning of an optoelectronic code with a scanner communicating with the computing unit inside the vehicle, wherein the alphanumeric and/or the optoelectronic code comprises an identifier of the passenger;
input of an alphanumeric code into the mobile device of the passenger and/or scanning of an optoelectronic code with the mobile device of the passenger, wherein the alphanumeric and/or optoelectronic code comprises an identifier of the vehicle carrying out the journey and/or of the at least one luggage compartment assigned to the passenger;
transmission of the passenger identifier from the mobile device of the passenger to the computing unit inside the vehicle via a first interface for wireless data transmission, in particular Bluetooth, Wi-Fi or NFC.

It is generally conceivable that the luggage compartment assigned to the passenger can be released during the journey time after the passenger is identified, for example via a passenger identifier such as a username or a customer number. The easiest way to transmit the passenger identifier to the computing unit inside the vehicle is to send the identifier present on the mobile device of the passenger directly to the computing unit inside the vehicle. It is also conceivable, however, that the passenger must additionally identify themselves according to one of the methods described above to increase security when using the method. It is thus necessary that the passenger is in spatial proximity, in particular directly on or in the vehicle. It is thus prevented that a passenger who has not begun their journey can release and lock the luggage compartment of the vehicle from a random location. A risk of misuse can thus be reduced.

It is possible to use the method for granting an access authorization for the luggage compartments even when the passenger does not bring a mobile device with them, in particular by using the alphanumeric and/or optoelectronic code. It is thus conceivable that the passenger has received an alphanumeric code after booking the journey, for example via email, which they can input in a code lock comprised by the luggage compartment during the journey to release the luggage compartment. It is conceivable that a new, currently valid alphanumeric code is accepted by the luggage compartment for each individual journey. It is thus prevented that passengers can use an old code several times. It is also conceivable that a ticket of the passenger has an optoelectronic code in the form of a barcode or a QR code that can be scanned by a central scanner of the vehicle or a scanner arranged on the luggage compartment in order to release the respective luggage compartment. The principle can also be reversed. It is thus conceivable that there is a central optoelectronic code characterising the vehicle, and/or that a corresponding optoelectronic code is provided on a few or on all of the luggage compartments, which can be scanned by the passenger with the assistance of their mobile device. A vehicle identifier and/or a luggage compartment identifier can thus be transmitted to the mobile device, which is sent in turn from the mobile device to the central computing unit outside the vehicle with an access request for the corresponding luggage compartment, and the central computing unit outside the vehicle then checks whether the passenger from whose mobile device this data was sent is authorized for access to the respective luggage compartment and, in the case that the passenger is authorized for access, sends a request to release the luggage compartment to the computing unit inside the vehicle.

By transmitting the passenger identifier from the mobile device of the passenger to the computing unit inside the vehicle via an interface for wireless data transmission, the luggage compartment can additionally be released particularly comfortably. The mobile device of the passenger thus acts as a key. It is thus conceivable that the individual luggage compartments comprise an NFC sensor and that the passenger only needs to hold their mobile device that supports NFC in front of the NFC sensor of the luggage compartment, whereby this luggage compartment is released for the journey time. Analogously, a vehicle and/or luggage compartment identifier can also be transmitted to the mobile device via NFC, which sends the identifier to the central computing unit outside the vehicle in turn and checks this identifier for the presence of an access authorization for the respective luggage compartment, and the luggage compartment is then released via the computing unit inside the vehicle.

Corresponding to a further advantageous embodiment of the method, a passenger can easily locate a luggage compartment assigned to them with the assistance of augmented reality by the passenger recording the vehicle with the assistance of a camera comprised by their mobile device, for example by filming or taking a photograph, and an image region of a camera image depicted on a display of the mobile device that corresponds to a position of the luggage compartment assigned to them is highlighted by overlay with a virtual graphic.

A luggage compartment assigned to a passenger can thus be particularly quickly and reliably located by the passenger. It is generally also conceivable that the individual luggage compartments have any physical identifier for identifying the luggage compartment, for example a sticker or an engraving. These identifiers can thus be provided with a pattern, a particular colour, a number, a codeword or the like. For the passenger to find their luggage compartment, however, they must check the identifiers of the luggage compartments until they find their luggage compartment. Conversely, the luggage compartment assigned to the passenger can be located particularly easily and quickly by the passenger by generating camera images showing the vehicle with the assistance of the mobile device. For this purpose, the luggage compartment can be virtually highlighted, for example by at least partial overlay with any colored symbol, in particular in a signal colour. The symbol can be a cross, a triangle, a circle, a square, any polygon and/or the like, for example. It is also possible to provide the luggage compartment assigned to the passenger with a frame that is lit up to identify the luggage compartment. In addition to a signal colour, the frame or the symbol can additionally have a different contrast, brightness and/or transparency to a background so that they can be clearly recognized. These can also cover the entire luggage compartment in the image depicted on the mobile device. It is generally also conceivable that a passenger only books a luggage compartment at the start of the journey. For example because they have already booked a luggage compartment and realize that the volume of the luggage compartment is not sufficient to receive the entirety of their luggage. They can thus spontaneously book an additional luggage compartment in order to also stow the rest of their luggage. For this purpose, luggage compartments that have already been booked can be highlighted with a different graphic. For example, such a luggage compartment can be provided with a red cross. The passenger is thus informed of which luggage compartments are still available to them to book.

A further advantageous embodiment of the method further provides that an item of luggage of the passenger can be measured with the assistance of the mobile device of the passenger in order to determine a luggage compartment having a minimum capacity suitable for receiving the item of luggage. In order to use an installation space of the vehicle as efficiently as possible, the luggage compartments can generally be designed such that different sizes or size classes can be assigned to them. If a passenger would like to stow only a little luggage or a small item of luggage, then they can book a small luggage compartment. If, however, they would like to stow a lot of luggage or a particularly large item of luggage, then they can book a correspondingly large luggage compartment. To make it easier for the passenger to find a suitable luggage compartment, they can film or photograph their items of luggage with the assistance of their mobile device, following which software executed on the mobile device and/or the central computing unit outside the vehicle determines a suitable luggage compartment on the basis of the camera images generated by the mobile device.

A released luggage compartment preferably locks automatically in the absence of a locking request, in particular after a pre-determined length of time has passed and/or when the vehicle drives away. If a passenger forgets to lock the luggage compartment assigned to them again after loading it, the danger arises that the items of luggage can fall out of the luggage compartment during the journey and/or that third parties can access the luggage compartment without authorization and steal items of the passenger's luggage. A luggage compartment can thus be automatically locked as an additional security measure. In particular after a pre-determined period of time has passed and/or after the vehicle drives away, it is no longer the case that the passenger might like to open their luggage compartment again. The luggage compartment can thus be particularly comfortably automatically closed at these points in time, as the passenger thus does not need to input the release request multiple times, which might potentially worsen an experience when using the luggage compartment.

An application executed on a mobile device of a passenger is equipped according to the invention to carry out a method described in the above. Carrying out method steps described in the above while using a mobile device is made particularly easy and comfortable by using a specific application, also known as an app. The app can be executed on any mobile device, for example a smartphone, tablet, laptop and/or the like. Luggage compartment booking, passenger identification, luggage compartment release or locking, support in locating a luggage compartment by using augmented reality and/or measuring luggage can in particular be carried out with the assistance of the app. A passenger can thus comfortably carry out all the steps relevant to using the luggage compartment. Additional functions can further optionally be added at a later point in time with the assistance of the app, additional information such as a delay of the vehicle can be shown to a passenger and user behaviour can be analysed to improve service in the form of the use of the luggage compartment according to the invention. Furthermore, particularly close contact with customers can be built up with the assistance of the app. A depiction of operating elements in the app can here be designed in any way. For example, an operating element for releasing or locking the luggage compartment assigned to the passenger can be visualized by a slider, a button or the like.

For a vehicle having at least two luggage compartments spatially separated from each other and/or able to be released and/or locked independently of each other, having at least one computing unit inside the vehicle and at least one interface for wireless data transmission, it is provided according to the invention that the computing unit inside the vehicle is equipped to enable a method as described above to be carried out. With the assistance of the computing unit inside the vehicle, the at least two luggage compartments can be released and/or locked independently of each other. The computing unit inside the vehicle can communicate with a central computing unit outside the vehicle via an interface for wireless data transmission. The computing unit inside the vehicle can communicate directly with mobile devices of passengers via an interface for wireless data transmission and/or indirectly via the central computing unit outside the vehicle. It can thus be checked whether a passenger has an access authorization for a luggage compartment assigned to them.

An advantageous development of the vehicle provides that at least two luggage compartments have a different capacity. As previously mentioned, an available instillation space of the vehicle can thus be used particularly efficiently. It can be assumed that different passengers will bring items of luggage of different sizes with them. If all the luggage compartments were designed to be suitable to receive a maximum luggage size, then valuable vehicle installation space would be wasted by receiving small items of luggage. By providing different luggage compartments having capacities differing from one another, flexibility when using the luggage compartments can be increased. Any number of different luggage size classes is possible. The vehicle can for example comprise luggage compartments having a luggage compartment size class of small, medium and large. More than three luggage size classes can also be provided, however. In addition to their capacity, the luggage compartments can in particular also differ in their geometric shape. A luggage compartment can thus for example have a particularly rectangular or oblong shape, for example for receiving skis, and a luggage compartment can in particular be a cube, for example for receiving a pram. The luggage compartments can also comprise different fixing devices for fixing items of luggage, for example hooks, loops, belts and/or the like.

Correspondingly to a further advantageous embodiment of the vehicle, at least one luggage compartment has a status display for visualising a released or locked status. The status display can be designed in any way. For example, in the simplest case, it can be a simple LED that is lit up green if the luggage compartment is released and is lit up red if it is locked, for example. The status display can also be formed by a display unit, for example, and also show additional information in addition to the status. It is generally also conceivable for the app to comprise the status display, for example during use of the augmented reality application for easily locating a luggage compartment assigned to a passenger. The graphic can thus be lit up green to highlight the luggage compartment assigned to the passenger, for example, if the luggage compartment assigned to them is released, and be lit up red if it is locked. Comfort when using the luggage compartments is thus improved.

The vehicle is preferably designed as a bus, in particular as a high-floor bus. The disadvantages described in the prior art can thus be avoided when using luggage compartments comprised by a bus. Generally, however, it can be any vehicle, such as a plane, rail vehicle, motor car, truck and/or the like.

Further advantageous embodiments of the method according to the invention for granting an access authorization for luggage compartments comprised by a vehicle, of the application and of the vehicle also result from the exemplary embodiments that are described in more detail in the following with reference to the figures.

### BRIEF DESCRIPTION OF THE DRAWINGS

FIG. 1 shows a side view of a vehicle according to the invention in the form of a high-floor bus;

FIG. 2 shows a schematic diagram of a communication path for passing on a release request to a computing unit inside the vehicle;

FIG. 3 shows an alternative schematic diagram of a communication path for passing on the release request to the computing unit inside the vehicle;

FIG. 4 shows a schematic depiction of an augmented reality-based support for locating a luggage compartment assigned to a passenger;

FIG. 5 shows a process diagram of a method according to the invention for releasing the luggage compartment assigned to the passenger; and

FIG. 6 shows a process diagram of an alternative method according to the invention for releasing the luggage compartment assigned to the passenger.

### DETAILED DESCRIPTION OF THE DRAWINGS

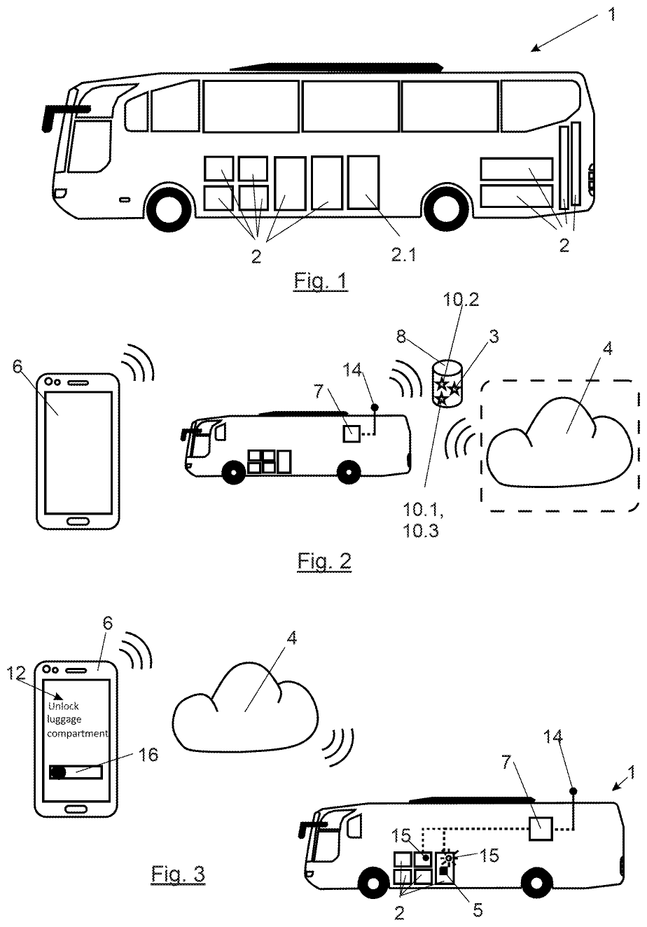

FIG. 1 shows a vehicle 1 according to the invention, here in the form of a high-floor bus, from one side. The high-floor bus comprises a plurality of luggage compartments 2 spatially separated from one another and able to be locked and released separately. The luggage compartments 2 can have a different capacity and shape, whereby passengers' items of luggage of different sizes can be transported by the high-floor bus in a particularly space-efficient manner. To lock or release the luggage compartments 2, the luggage compartments are locked with a locking mechanism of any kind. For example, an opening of a luggage compartment 2 is locked with a foldable or pivotable flap, which is fixed in a locked position by a magnetic lock, for example.

To release a luggage compartment 2.1 assigned to a passenger, a passenger can initiate a release request to release the luggage compartment 2.1 assigned to them via their mobile device 6 depicted in FIG. 2, here in the form of a smartphone. According to a first communication path, the release request is transferred from the mobile device 6 directly via a first or second 14 interface for wireless data transmission to a computing unit 7 inside the vehicle. This release request comprises at least one identifier of the passenger 10.2, for example a username or a customer number. To inform the computing unit 7 inside the vehicle of whether a passenger behind the passenger identifier 10.2 can access the luggage compartment 2.1 they have requested, the computing unit 7 inside the vehicle requests access authorization data 8 from a central computing unit 4 outside the vehicle. In addition to a passenger identifier 10.2, the access authorization data 8 also comprises a time 3 at which the passenger undertakes a journey with the vehicle 1, and an identifier 10.1 of the vehicle 1 and/or an identifier 10.3 of a luggage compartment 2.1 assigned to the passenger. By comparing these three identifiers 10.1 and/or 10.3, 3 and 10.3 via the computing unit 7 inside the vehicle, the computing unit is in the position to decide whether or not the passenger may receive access to the luggage compartment 2.1 they have requested to open. The access authorization data 8 can be requested from the central computing unit 4 outside the vehicle after the release request is received from the computing device 7 inside the vehicle or be transferred to the computing device 7 inside the vehicle, or the computing device 7 inside the vehicle can request the access authorization data 8 before the journey is carried out at or before the time 3, and thus before the release request is received. This is indicated in FIG. 2 by a dashed border of the central computing unit 4 outside the vehicle. The access authorization data 8 can generally only comprise the access authorization data of the passenger making the release request, or the access authorization data 8 can comprise the access authorization data of all the passengers carrying out the journey with the vehicle 1 at the time 3.

FIG. 3 shows an alternative communication path for passing on the release request to the computing unit 7 inside the vehicle, in which checking whether the passenger has access to the luggage compartment 2.1 they have requested is carried out by the central computing unit 4 outside the vehicle. For this purpose, the release request transmitted from the mobile device 6 of the passenger is sent directly to the central computing unit 4 outside the vehicle, which checks whether the passenger has access to the luggage compartment 2.1 they have requested, and in the case that the passenger has access, a command to release the corresponding luggage compartment 2.1 is transmitted to the computing unit 7 inside the vehicle via the second interface for wireless data transmission 14. To input the release request into the mobile device 6 of the passenger, an application equipped for this purpose is executed on the mobile device 6. For example, a slider 16 is depicted on the display 12 of the mobile device 6, which can be slid from a position on the left to a position on the right, whereupon the release request is transmitted by the mobile device 6 after the slider is slid to the position on the right. The release request can thus be sent particularly aesthetically and comfortably. Generally, an operating element depicted in any way on the display 12 can be used to release or lock the luggage compartment.

Alternatively or in addition, the release request can also be transmitted by operating a device comprised by the vehicle 1 for inputting operating actions 5. This device can be designed in many ways. For example, the device can be a scanner for scanning optoelectronic codes, a keypad for inputting an alphanumeric code or an NFC sensor for sending and receiving NFC signals. The release request can also be transmitted to the computing unit 7 inside the vehicle by a passenger holding their mobile device 6 over a device for inputting operating actions 5 in the form of an NFC sensor. The passenger can thus additionally identify themselves, and confirm that they are in an immediate environment of the vehicle 1, whereby the luggage compartment 2.1 assigned to them can be released particularly reliably and securely. To display a status, for example a locked or released status, at least one luggage compartment 2 can have a status display 15 for visualising the status. The display can be an LED for example, which is switched off in a locked status and which is lit up in a released status.

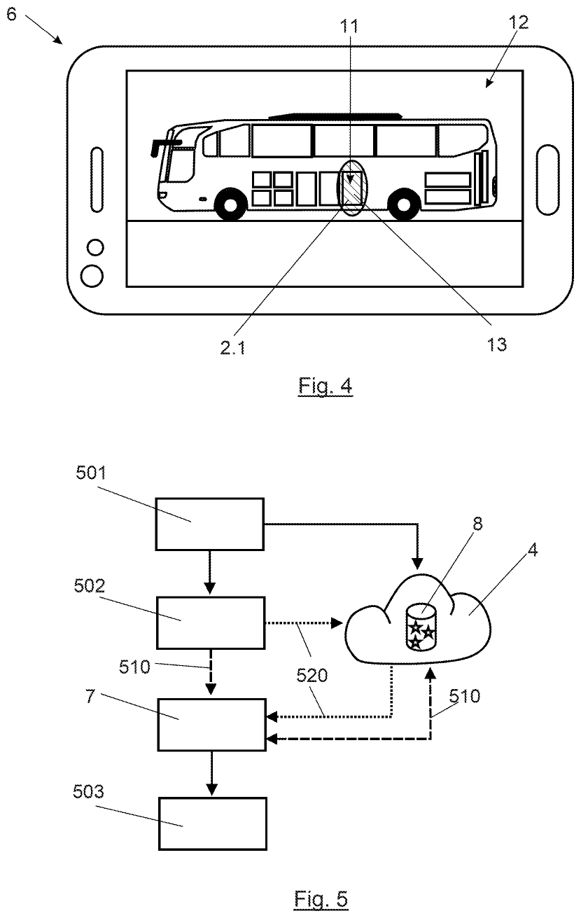

FIG. 4 shows a view from above of a display 12 of the mobile device 6, wherein a passenger uses their mobile device 6 to quickly and reliably locate a luggage compartment 2.1 assigned to them with the assistance of augmented reality. The passenger holds their mobile device 6 such that a camera comprised by the mobile device 6 records the vehicle 1, whereby the app executed on the mobile device 6 locates the luggage compartment 2.1 assigned to the passenger, and at least one image region 11 of the display 12 corresponding to the luggage compartment 2.1 assigned to the passenger is at least partially overlaid with a graphic 13 for better identification in order to show the passenger the position in which the luggage compartment 2.1 assigned to them is located. The graphic 13 can be designed in any way. For example, it can be a colored surface that is rectangular, circular or any other shape. In particular, a colour, contrast, brightness and/or transparency of the graphic 13 can be designed such that a passenger can easily recognize a luggage compartment 2.1 assigned to them. The graphic 13 on the display 12 of the mobile device 6 can have a surface completely received by the luggage compartment 2.1 or only partially overlay the luggage compartment 2.1 The graphic 13 can additionally at least partially comprise numbers and/or text.

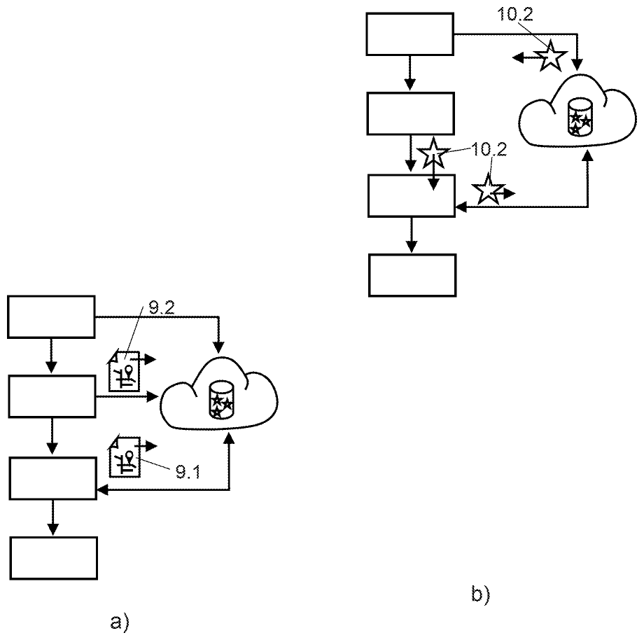

In the process diagram depicted in FIG. 5, in step 501, a passenger books a luggage compartment 2 for a journey carried out by at least one vehicle 1 at a particular time 3. A change of vehicle 1 can also be made during the journey from a starting stop to a target stop. With the assistance of the method according to the invention, a respective luggage compartment 2 of the vehicles 1 used by the passenger for the journey is booked. A luggage compartment is thus provided for the passenger particularly comfortably even when changing. During the booking, access authorization data 8 is deposited in the central computing unit 4 outside the vehicle, which data comprises a passenger identifier 10.2, the time 3 at which the journey is carried out and an identifier 10.1 of the at least one vehicle 1 with which the journey is carried out and/or an identifier 10.3 of the luggage compartment 2.1 reserved by the passenger. In step 502, the passenger inputs a release request to release the luggage compartment 2.1 assigned to them. In accordance with a first path 510, this request can be transmitted directly to the computing unit 7 inside the vehicle, which then communicates with the central computing unit 4 inside the vehicle to view the access authorization data 8, so that the computing unit 7 inside the vehicle can decide whether or not the passenger should receive access to the requested luggage compartment 2.1. In accordance with a second, alternative communication path 520, the release request can additionally or alternatively also be transmitted to the central computing unit 4 outside the vehicle, whereupon this central computing unit carries out the access authorization check and, in the case of a positive result, gives a confirmation of the release of the luggage compartment 2.1 to the computing unit 7 inside the vehicle. In step 503, the luggage compartment 2.1 is finally released.

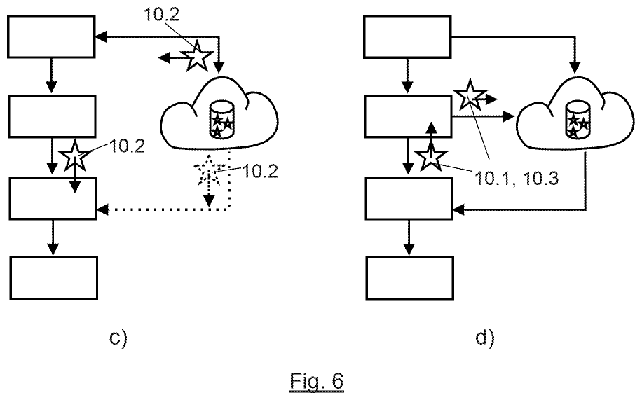

As additional security, to ensure that the passenger is in the immediate vicinity of the vehicle 1, an additional identification feature or validation feature can be transmitted to the central computing unit 4 outside the vehicle and/or the computing unit 7 inside the vehicle. This is depicted in FIG. 6. FIG. 6a) shows an additional identification feature in the form of vehicle GPS coordinates 9.1 and passenger GPS coordinates 9.2, which are sent from the mobile device 6 of the passenger or the computing unit 7 inside the vehicle to the central computing unit 4 outside the vehicle.

FIG. 6b) shows the additional identification feature in the form of an additional passenger identifier 10.2, which is transmitted from the central computing unit 4 outside the vehicle to the passenger after the luggage compartment 2.1 is booked, and is then transmitted by the passenger to the computing unit 7 inside the vehicle, for example by scanning an optoelectronic code with a scanner communicating with the computing unit 7 inside the vehicle, or by reading an NFC signal transmitted from a mobile device 6, which is then sent to the central computing unit 4 outside the vehicle to be checked.

As FIG. 6c) shows, the additional passenger identifier 10.2 can also have been transmitted to the computing unit 7 inside the vehicle before the journey begins, and thus before the release request was received (dashed line). This increases reliability of the method according to the invention for releasing luggage compartments 2.1 in a region with limited radio reception.

In accordance with FIG. 6d), the computing unit 7 inside the vehicle transmits an additional identifier 10.1 and/or 10.3 characterising the vehicle 1 and/or the luggage compartment 2.1 assigned to the passenger to the mobile device 6 of the passenger, for example by the passenger scanning an optoelectronic code, for example a QR code, arranged on an outside of a luggage compartment 2. The mobile device 6 of the passenger then transmits the additional identifier 10.1 and/or 10.3 to the central computing unit 4 outside the vehicle, which then carries out the check of the access authorization.

1.-10. (canceled)

11. A method for granting an access authorization for luggage compartments (2) of a vehicle (1), wherein the vehicle (1) has at least two luggage compartments (2) spatially separated from each other and releasable and/or lockable independently of each other, comprising the steps of:
booking at least one luggage compartment (2) for a journey from a starting stop to a target stop carried out by the vehicle (1) at a pre-determined time (3) by a passenger via a booking portal;
assigning at least one of the luggage compartments (2) of the vehicle (1) carrying out the journey to the passenger via a central computing unit (4) outside of the vehicle (1) such that the passenger receives an access authorization for precisely this luggage compartment (2) for a duration of the journey;
inputting a request for granting a release of the at least one luggage compartment (2.1) assigned to the passenger into a device for inputting operating actions (5) of the vehicle (1) or into a mobile device (6);
checking the access authorization of a person inputting the request via a computing unit (7) inside of the vehicle and/or the central computing unit (4) outside of the vehicle, wherein, in a case of the checking by the computing unit (7) inside of the vehicle, the computing unit (7) receives or accesses access authorization data (8) from the central computing unit (4) outside of the vehicle before carrying out the checking; and
in a case that the person inputting the request is authorized for access, releasing the at least one luggage compartment (2.1) assigned to the passenger via the computing unit (7) inside of the vehicle.

12. The method according to claim 11, further comprising the steps of:
identifying the passenger by the passenger by at least one of the following methods directly at the computing unit (7) inside of the vehicle or indirectly via the central computing unit (4) outside of the vehicle before the releasing:
comparing of a current GPS position (9.1) of the vehicle (1) carrying out the journey with a current GPS position (9.2) of the passenger, wherein the current GPS position (9.2) of the passenger is determined by a mobile device (6) of the passenger;
inputting of an alphanumeric code into the device for inputting operating actions (5) of the vehicle (1) and/or scanning of an optoelectronic code with a scanner communicating with the computing unit (7) inside of the vehicle, wherein the alphanumeric and/or the optoelectronic code comprises an identifier (10.2) of the passenger;
inputting of an alphanumeric code into the mobile device (6) of the passenger and/or scanning of an optoelectronic code with the mobile device (6) of the passenger, wherein the alphanumeric and/or optoelectronic code comprises an identifier (10.1) of the vehicle (1) carrying out the journey and/or an identifier (10.3) of the at least one luggage compartment (2.1) assigned to the passenger; and
transmitting of the passenger identifier (10.2) from the mobile device (6) of the passenger to the computing unit (7) inside of the vehicle via a first interface for wireless data transmission.

13. The method according to claim 11, wherein a passenger can easily locate a luggage compartment (2.1) assigned to them with assistance of augmented reality by the passenger recording the vehicle (1) with assistance of a camera of their mobile device (6), wherein the camera generates camera images, and an image region (11) of a camera image depicted on a display (12) of the mobile device (6) that corresponds to a position of the luggage compartment (2.1) assigned to them is highlighted by overlay with a virtual graphic (13).

14. The method according to claim 13, wherein an item of luggage of the passenger is measurable with assistance of the mobile device (6) of the passenger in order to determine a luggage compartment (2) having a minimum capacity suitable for receiving the item of luggage.

15. The method according to claim 11, wherein a released luggage compartment (2) locks automatically in absence of a locking request after a pre-determined period of time has passed and/or when the vehicle (1) drives away.

16. A mobile device (6) of a passenger that is configured to perform the method according to claim 11.

17. A vehicle (1), comprising:
at least two luggage compartments (2) spatially separated from each other and releasable and/or lockable independently of each other;
a computing unit (7) inside of the vehicle; and
an interface (14) for wireless data transmission;
wherein the computing unit (7) is configured to perform the method according to claim 11.

18. The vehicle (1) according to claim 17, wherein the at least two luggage compartments (2) have different respective capacities.

19. The vehicle (1) according to claim 17, wherein at least one luggage compartment (2) of the at least two luggage compartments (2) has a status display (15) for visualizing a released or locked status.

20. The vehicle (1) according to claim 17, wherein the vehicle is a high-floor bus.
